(19) United States
(12) Patent Application Publication
(10) Pub. No.: US 2014/0173428 A1
(43) Pub. Date: Jun. 19, 2014

(54) ELECTRONIC DEVICE AND METHOD FOR IMPORTING EMAIL ONTO EDITING INTERFACE THEREOF

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: LING-JUAN JIANG, Shenzhen (CN); CHIH-SAN CHIANG, New Taipei (TW); HUA-DONG CHENG, Shenzhen (CN); HAI-SEN LIANG, Shenzhen (CN); HAI-JUN MAO, Shenzhen (CN); TE-JIA LIU, Shenzhen (CN); XIAO-GUANG LI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/105,190

(22) Filed: Dec. 13, 2013

(30) Foreign Application Priority Data
Dec. 13, 2012 (CN) 2012105367319

(51) Int. Cl. G06F 17/24

(52) U.S. Cl. CPC G06F 17/24
USPC 715/256

(57) ABSTRACT

A method for importing an email onto an editing interface of an electronic device includes the following steps. Firstly, create a new notepad page comprising an editing interface when a notepad application is activated. Secondly, receive user input signals. Thirdly, determine whether a user input operation requires the import of an email onto the editing interface of the new notepad page and select an email stored in an email box in response to an email selection operation and further directly import the selected email onto the editing interface of the new notepad page for editing and personalization. And then delivery the edited document as an outbound email. A related electronic device is also provided.

### BACKGROUND

1. Technical Field

The present disclosure relates to electronic devices and methods for importing emails for electronic devices, and particularly to an electronic device and a method for importing an email onto an editing interface of the electronic device.

2. Description of Related Art

A conventional method for importing an email onto an interface of a notepad-type editing program includes the steps of opening an editing interface of an electronic device; linking to an email box; opening an email stored in the email box; copying or cutting the content of the email; and pasting the content of the email on the interface of the notepad-type editing program. Then, the user can edit the content of the email on the interface of the notepad-type editing program. However, the conventional method is inconvenient and cumbersome.

Therefore, what is needed is an electronic device and a method for importing an email onto an editing interface of the electronic device, which can alleviate the limitations described above.

### BRIEF DESCRIPTION OF THE DRAWINGS

The emphasis is placed upon clearly illustrating the principles of the present disclosure.

FIG. 1 is a block diagram of an electronic device in accordance with an embodiment of the present invention.

FIG. 2 is a flowchart of a method for importing an email onto an editing interface of an electronic device, such as the one of FIG. 1, in accordance with an embodiment of the present invention.

### DETAILED DESCRIPTION

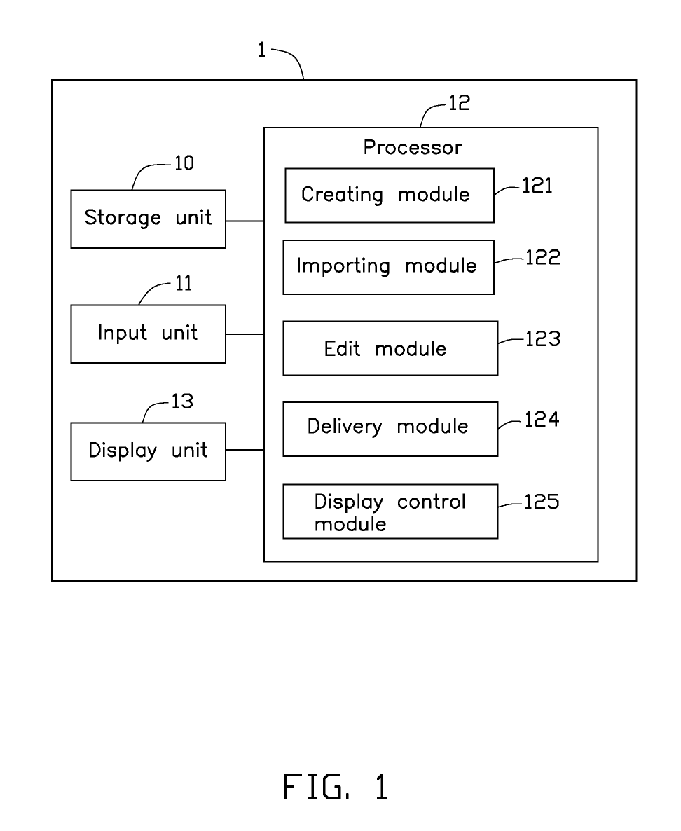

FIG. 1 is a block diagram of an embodiment of an electronic device 1. The electronic device 1 is typically a terminal device such as a personal computer, a mobile phone, or a tablet computer, for example. The electronic device 1 has a notepad application installed therein. The notepad application can be used for editing emails, recording handwritten signatures of users, inserting images, and the like. In the following description, unless the context indicates otherwise, a reference to an “email” is a reference to the text of a message sent electronically.

The electronic device 1 includes an input unit 11. The input unit 11 is selected from the group consisting of a touch screen, an actual keypad, a touchpad, and a virtual keypad. The input unit 11 generates input signals in response to user operations applied thereon. In this embodiment, the input unit 11 is a touch screen.

The electronic device 1 further includes a storage unit 10, a processor 12, and a display unit 13. The storage unit 10 stores the notepad application, and data required by and created by the electronic device 1.

The processor 12 includes a creating module 121, an importing module 122, an edit module 123, a delivery module 124, and a display control module 125.

When the electronic device 1 is activated, the display unit 13 displays a default icon interface including a notepad icon. When the notepad icon is touched (via the touch screen of the input unit 11), a notepad application is activated.

The creating module 121 is configured for creating a new notepad page when the notepad application is activated. The new notepad page includes an editing interface.

The importing module 122 determines whether or not a user input operation is an operation for importing an email stored in an external email box onto the editing interface of the new notepad page in response to input signals generated by the input unit 11. When the user input operation is an operation for importing an email stored in an email box onto the editing interface of the new notepad page, then the email stored in the email box is selected in response to an email selection operation applied on the input unit 11, and the selected email is imported onto the editing interface of the new notepad page.

A detailed example of the operation of importing an email stored in an email box onto the editing interface of the new notepad page is as follows. A user may select a virtual “import email” button displayed through the touch screen of the input unit 11. In response to the selection, the importing module 122 firstly provides an input box for the user to input the website (World Wide Web address) of an email box. After such input, the importing module 122 creates a communication link to the input email box. Then the importing module 122 selects an email stored in the email box in response to an email selection operation applied on the input unit 11 by the user, and imports the selected email onto the editing interface of the new notepad page. Thus, the importing module 122 can control the electronic device 1 to communicate with an external device (such as a server) linked to the Internet.

In an alternative embodiment, the importing module 122 further divides the content of the email into a number of segments, and then imports the segments onto the editing interface of the new notepad page one by one. For example, if the displayed content of the email is three times longer than a predetermined length, the importing module 122 divides the email into three segments.

The edit module 123 edits the imported email in response to user editing inputs made via the input unit 11. The edit module 123 is further configured for editing other content displayable on the editing interface of the new notepad page in response to user editing inputs made via the input unit 11, such as adding handwritten signatures, inserting images, and effecting other personalization edits, for example. All the edits are displayable on the editing interface in real time.

The delivery module 124 delivers the edited email to one or recipient addresses.

The display control module 125 controls the display unit 13 to display a notepad page when the notepad application is activated; and to display the new notepad page created by the creating module 121, including the editing interface of the new notepad page. When an imported email is edited, the display control module 125 controls display of the edits on the editing interface in real time.

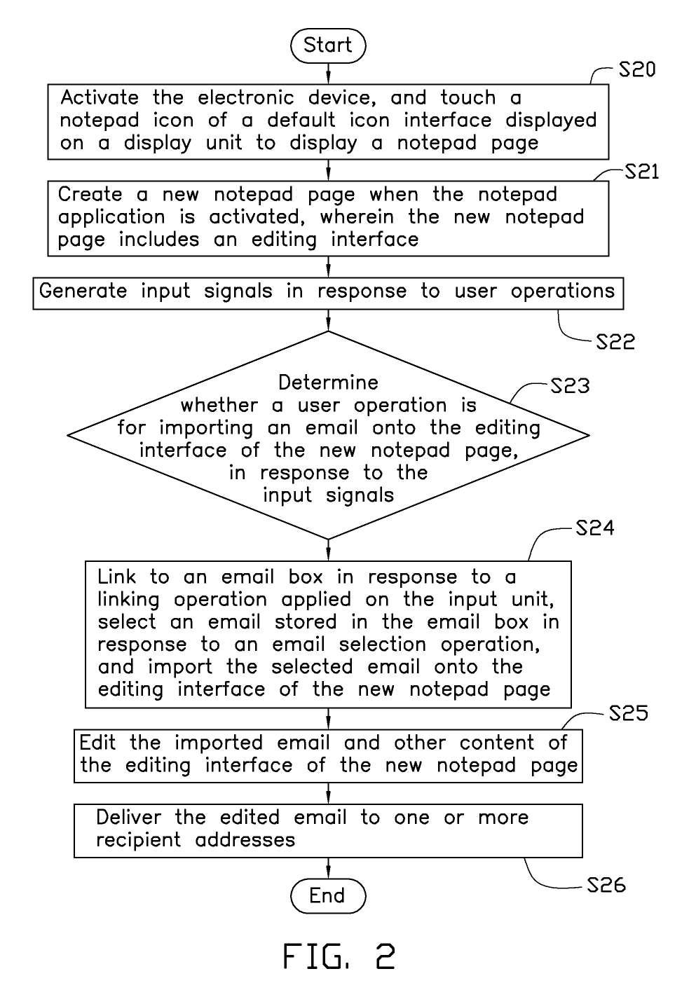

FIG. 2 shows a flowchart of a method for importing an email onto an editing interface of an electronic device such as the electronic device 1. The electronic device 1 includes a storage unit 10 and an input unit 11. The input unit 11 generates signals in response to user inputs. The method typically includes the following steps, each of which is carried out by the various components contained in the electronic device 1.

In step S20, when the electronic device 1 is activated, the display unit 13 displays a default icon interface including a notepad icon. In the embodiment, when the notepad icon is touched, the notepad application is activated, and the display control module 125 controls the display unit 13 to display a notepad page.

In step S21, the creating module 122 creates a new notepad page when the notepad application is activated. The new notepad page of the notepad application includes an editing interface, and the display control module 125 controls the display unit 13 to display the new notepad page including the editing interface.

In step S22, the input unit 11 generates signals in response to user input operations.

In step S23, the importing module 122 determines whether a user operation is for importing an email stored in an external email box onto an editing interface of the new notepad page, in response to the input signals. If the determination is yes, the process goes to step S24. If the determination is no, the process goes back to step S22.

In step S24, the importing module 122 firstly links to an email box in response to a linking operation required by the input unit 11, then selects an email stored in the email box in response to an email selection operation applied on the input unit 11, and finally imports the selected email onto the editing interface of the new notepad page.

In step S25, the edit module 123 edits the imported email as required by the user via the input unit 11. In addition, the edit module 123 edits other content displayed on the editing interface of the new notepad page as required by the user via the input unit 11, such as adding handwritten signatures, inserting images, and effecting other personalization edits for example.

In step S26, the delivery module 124 delivers the edited email to one or more recipient addresses.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A method for importing an email onto an editing interface of an electronic device, the method comprising:
creating a new notepad page comprising an editing interface when a notepad application is activated;
generating input signals in response to user operations;
determining whether a user operation is for importing an email onto the editing interface of the new notepad page; and
selecting an email stored in an email box in response to a user email selection operation and importing the selected email onto the editing interface of the new notepad page when the user operation is for importing an email onto the editing interface of the new notepad page.

2. The method as described in claim 1, further comprising, before selecting an email stored in an email box in response to a user email selection operation and importing the selected email onto the editing interface of the new notepad page when the user operation is for importing an email onto the editing interface of the new notepad page:
linking to the email box.

3. The method as described in claim 1, further comprising, after selecting an email stored in an email box in response to a user email selection operation and importing the selected email onto the editing interface of the new notepad page when the user operation is for importing an email onto the editing interface of the new notepad page:
editing the imported email in response to editing inputs of a user.

4. The method as described in claim 3, wherein edits of the imported email are displayed on the editing interface in real time.

5. The method as described in claim 1, wherein importing the selected email onto the editing interface of the new notepad page comprises:
dividing the content of the email into a plurality of segments; and
importing the segments onto the editing interface of the new notepad page one by one.

6. An electronic device, comprising:
a storage unit having a notepad application stored therein;
a creating module, configured for creating a new notepad page comprising an editing interface when the notepad application is activated;
an input unit, configured for generating input signals in response to user operations; and
an importing module, configured for determining whether a user operation is for importing an email onto the editing interface of the new notepad page, for selecting an email stored in an email box in response to a user email selection operation applied on the input unit, and for importing the selected email onto the editing interface of the new notepad page when the user operation is for importing an email onto the editing interface of the new notepad page.

7. The electronic device as described in claim 6, wherein the importing module is configured for firstly linking to an email box in response to a linking operation applied on the input unit, and then selecting an email stored in the email box in response to a user email selection operation applied on the input unit.

8. The electronic device as described in claim 6, wherein the importing module is further configured for dividing the content of the email into a plurality of segments and importing the segments onto the editing interface of the new notepad page one by one.

9. The electronic device as described in claim 6, further comprising:
an edit module, configured for editing the imported email in response to editing inputs.

10. The electronic device as described in claim 6, further comprising:
a display unit; and
a display control module, configured for controlling display of the editing interface of the new notepad page on the display unit.

11. The electronic device as described in claim 10, further comprising:
an edit module, configured for editing the imported email in response to editing inputs, wherein the display control module is further configured for controlling display of edits of the imported email on the editing interface in real time.
